(19) United States
(12) Patent Application Publication
(10) Pub. No.: US 2017/0030473 A1
(43) Pub. Date: Feb. 2, 2017

(54) AUTOMATIC SHUTOFF VALVE FOR A PIPELINE

(71) Applicant: Deatech Consulting Company, Montgomery, TX (US)

(72) Inventor: Royce Don Deaver, Montgomery, TX (US)

(73) Assignee: DEATECH CONSULTING COMPANY, Montgomery, TX (US)

(21) Appl. No.: 14/812,094

(22) Filed: Jul. 29, 2015

(51) Int. Cl. F16K 15/18; F16K 1/18; F16K 3/30; F16K 31/122

(52) U.S. Cl. CPC F16K 15/186; F16K 31/122; F16K 1/18; F16K 3/30

(57) ABSTRACT

A valve in a pipeline is automatically configured to close the flow through the pipeline in the event of a pipeline rupture or similar event. During normal flow, a valve element is maintained in an open position. However, in the event of a rupture, the resulting pressure drop across the valve is sensed and causes the valve element to move to a closed position.

### BACKGROUND OF THE INVENTION

Field of the Invention

This invention is directed to an automatic shutoff valve for a fluid pipeline, which may convey gas or oil for example. The valve is located within the pipeline and will automatically close in response to a drop in pressure which may be the result of a pipeline rupture or other emergency shutdown event.

Description of Prior Art

Pipeline owners are required by federal regulations to provide the capability of emergency shutdown of pipeline. Typically this is accomplished by providing valves in the pipeline which are either manually controlled, remotely controlled, or operate automatically.

Experience has indicated that excessive delays have occurred in manually closing valves after a rupture and that without early detection, remotely controlled valves are of little value. Industry studies have determined that:
1. Both field and computer simulation studies have shown the major reliability problem of these systems results from the fact that no pipeline flow parameter has been identified that will serve as an adequate line break detection signal in all applications.
2. Rate of pressure drop (ROPD), for example, is inadequate in many pipeline applications where operating transients from compressor stations, valve change, etc. are comparable in magnitude to the transient signals developed by a line break. Other approaches have been attempted, but none have demonstrated adequacy for all applications.
3. The safety benefits of early valve closure lies in shortening the duration of line blowdown and when early ignition occurs, of reducing the effect of long-term thermal radiation.
4. In most cases, ignition occurs within the first 10 minutes. Early shutoff will reduce the prolonged heating of nearby structures and reduce the magnitude of injuries and property damage.

An ideal shutoff valve will close in seconds, not minutes or hours. An ideal automatic shutoff valve will not rely upon external instrumentations and human interpretation to determine when to close the valve and does not require an external source of power to close the valve. Also the ideal valve does not require a remote action to close the valve and does not exhibit a fail-safe function to needlessly close. Lastly an ideal valve would be less expensive than automatic and remote control valves and would be based on current and proven technology to the extent possible.

### BRIEF SUMMARY OF THE INVENTION

These and other needs in the art are addressed by the instant invention by providing an automatic shutoff valve that is actuated by sensing a drop in pressure in the flow line. A valve closure member is responsive to a higher flow rate and pressure drop across the valve to move a valve element to a closed position. The valve element is normally held in an open position by a static force provided for example by weights attached to the valve element or by the weight of the valve element itself. The valve element may be a hinged flapper type valve element or a gate type valve element.

### BRIEF DESCRIPTION OF THE DRAWINGS

For a detailed description of the preferred embodiments of the invention, reference will now be made to the accompanying drawings in which:

FIG. 1 is a cross sectional view of a first embodiment of the invention.

FIG. 2 is a cross sectional view of a second embodiment of the invention.

FIG. 3 is a cross sectional view of a third embodiment of the invention.

### DETAILED DESCRIPTION OF THE PREFERRED EMBODIMENTS

To illustrate various illustrative embodiments of the present invention, the following examples are provided.

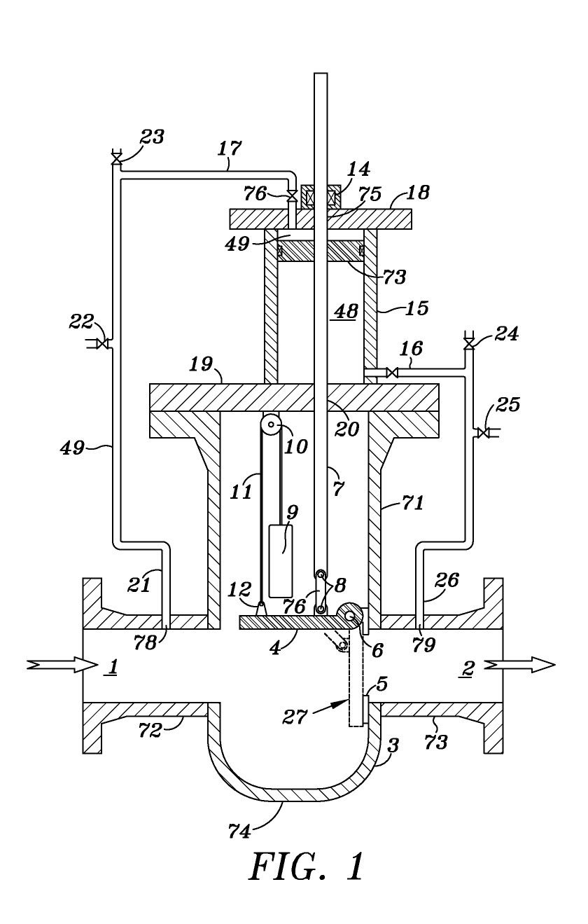

As shown in FIG. 1, a first embodiment of the invention includes a valve housing having an inlet portion 72 with an inlet flow path 1, a middle portion 3 and an outlet portion 73 having an outlet flow path 2. Inlet portion 1 and outlet portion 2 are adapted to be suitably connected in a pipeline by welding or bolts as in known in the art.

A flapper valve element 4 is pivotally connected at 6 to an internal portion of the middle housing portion 3 and is normally held in an open position as shown in FIG. 1. A valve seat 5 cooperates with flapper valve element 4 to shutoff flow through the valve as shown in phantom at 27.

The valve housing further includes a vertically extending portion 71 which may be cylindrical or rectangular in shape. Vertical extending housing 71 is closed at its upper end by a top plate 19 which includes an opening 20 for the valve stem 7.

A fluid cylinder 15 is attached to the top plate 19 and in turn is closed by a second top plate 18 which includes an opening 75 for the valve stem 7.

Flapper valve element 4 is normally held in an open position by a weight 9 suspended around a pulley 10 or other mechanism within housing 71. A cable 11 is attached at one end to weight 9 and at a second end to flapper valve element 4 at 12.

A valve stem 7 extends through top plates 18 and 19 through openings 75 and 20 and is connected to flapper valve element 4 by a flexible link 76 that is pivoted at 8 to both flapper valve element 4 and valve stem 7 to allow the flapper valve element to move from the open position to the closed position 27 shown in phantom in FIG. 1.

A piston 73 is positioned within fluid cylinder 15 and is fixedly attached to valve stem 7. The volume 49 above piston 73 is in fluid communication with the inlet flow path 1 via port 78, control lines 21, 49, 17 and valve 76. Valve 22 allows external pressure to reposition the piston and flapper valve element 4. A vent 23 allows for purging or relieving pressure acting in control line 17.

The lower volume 48 of cylinder 15 is in fluid communication with outlet 2 of the valve via control line 16, 26, and port 79. A valve 25 allows for external pressure to reposition the piston 13 and valve stem 7. A vent 24 allows for purging or relieving pressure within control line 16.

Upper portion 49 of the fluid cylinder 15 contains pressure equal to the inlet pressure of the valve at 1 and the lower portion 48 of the fluid cylinder 15 contains pressure equal to the outlet pressure of the valve at 2. In a steady state open flow situation, the pressure drops across the valve is not sufficient to overcome the force of the weight 9. However, should a rupture occur, the pressure drop across the valve will be significantly higher. When a pipeline rupture occurs, the differential pressure across the valve increases with the square of the gas flow rate and velocity. Depending on the proximity to the rupture, the differential pressure across the valve can increase by a factor of five to twenty five or even more depending on how close the valve is to the rupture.

Thus when a rupture occurs, the pressure acting on the top of piston 13 is great enough to overcome the force of the weight 9. This causes valve stem to move downwardly to move flapper valve element to a closed position shown in phantom in FIG. 1.

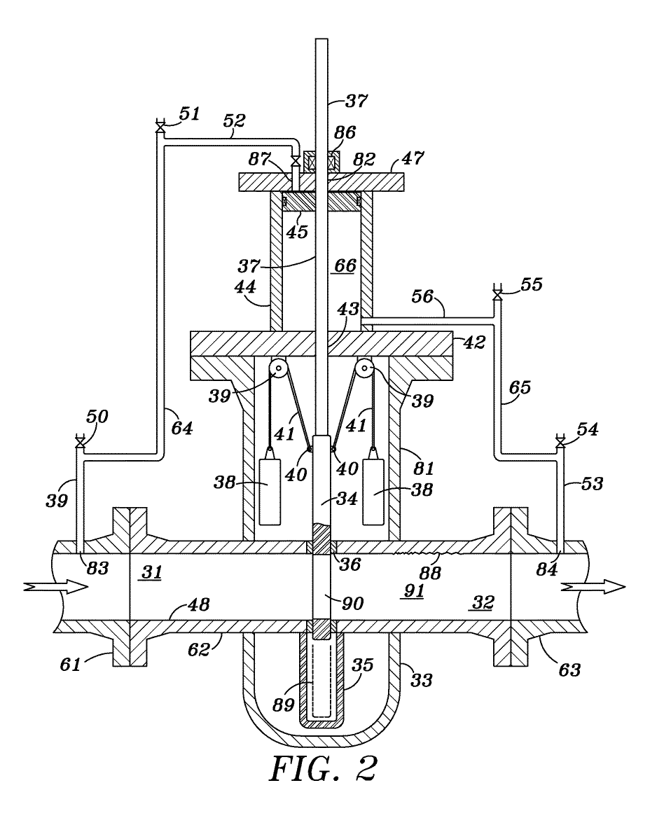

A second embodiment of the invention is shown in FIG. 2. The operating principles are very similar to the embodiment of FIG. 1. A gate valve element 34 having an opening 90 however is utilized in lieu of a flapper valve element.

Referring to FIG. 2, the valve includes a central valve housing 62 having an inlet flow path 31 and an outlet flow part 32. An inlet connector 61 includes a port 83 and outlet connector 63 includes a port 84. Inlet and outlet connectors 61 and 63 are suitably connected for example by welding or bolts to central valve housing 62. A lower valve housing 33 which may be circular in shape extends below central valve housing 62 and houses a retainer member 35 which supports gate valve element 34 in the closed position shown in phantom at 89. A pair of seals 36 are located on the sides of the gate valve to seal the valve in the closed position.

The valve housing further includes an upper portion 81 which houses one or more weights 38 which are attached to the gate valve element 34 at 40 via a pair of cables 41 that pass over a pair of pulleys 39 or other mechanisms secured within upper housing member 81. Thus weights 38 exert an upward force on valve stem 37 and gate valve 34 to keep the valve open during normal operation.

Top plate 42 closes upper housing portion 81 and has an opening 43 through which valve stem 37 passes. A fluid cylinder 44 is positioned on top of top plate 42 and includes a second top plate 47 which has an opening 82 through which valve stem 37 passes. A seal 86 surrounds valve stem 37 at the opening 82. A passageway 87 extends through second top plate 47 and is connected to control line 52.

A piston 45 is fixedly secured to valve stem 37 and is located within fluid chamber 44.

Pressure at valve inlet 31 is communicated to the upper side of piston 45 via port 83 and control line 39, 64, and 52. Valve 50 allows external pressure to be used to test or reposition the valve to a closed position. A vent 51 allows venting of pressure within control lines 39, 64, 52.

Pressure at valve outlet 32 is communicated to the lower side of piston 45 via port 84, control lines 53, 65, and 56.

Valve 54 allows venting and permits an external pressure source to be used to test or reposition the valve to an open position. Valve 55 is a vent valve to allow venting of the pressure within control lines 56, 65, and 53.

In the normal flow condition the magnitude of the weights 38 are selected to maintain gate valve 34 in the open position shown in FIG. 2. The differential pressure acting on the piston during normal operation is not sufficient to overcome the force of the weights and gate valve 34.

However, as explained above with references to the embodiment of FIG. 1, a rupture in the pipe line will cause a significant pressure drops across the valve that will be sufficient to overcome the force of the weights and thus move piston 45 in a downwardly direction. This in turn will cause gate valve to move downwardly and close the gate valve as shown in phantom at 89 thereby shutting off flow through the valve in a manner known in the art.

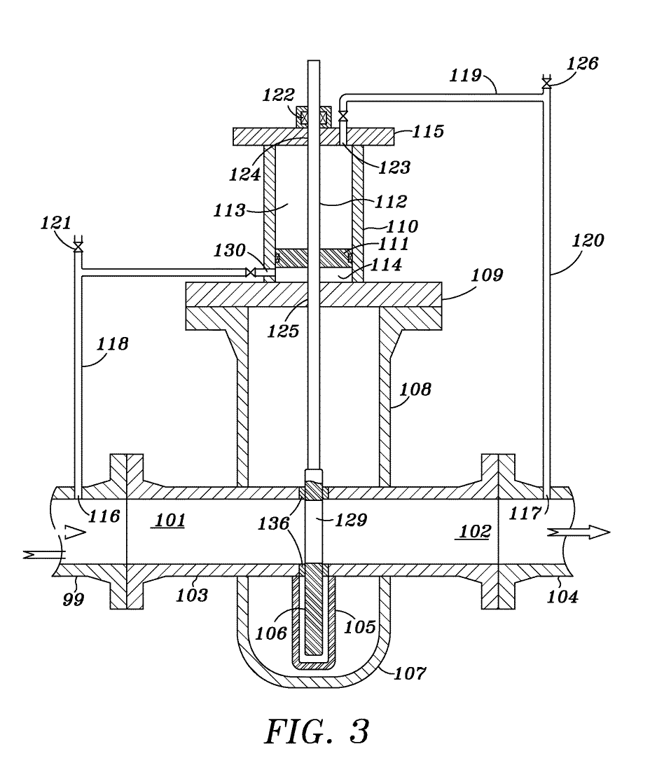

FIG. 3 illustrates a third embodiment of the invention. The embodiment utilizes the weight of the valve stem and gate valve as the biasing force to maintain the valve in a closed position. An increase in the differential pressure across the valve results in an upward movement of the piston, valve stem, and gate valve assembly.

The valve housing 103 includes an inlet 101 and outlet 102. The valve can be secured to pipeline sections 99 and 104 as is known in the art. The valve housing also includes a lower portion 107 which includes a guide 105 to position the gate valve 106 in the open position.

The valve housing further includes an upper portion 108 having a top plate 109 which includes an opening 125. A fluid chamber 110 is positioned on top plate 109 and is closed by a second top plate 115 which has an opening 124 and seal 122 through which valve stem 112 extends. A fluid passageway 123 also extends through top plate 123.

A piston 111 is positioned within fluid chamber 110 and is fixed to valve stem 112. Valve stem 112 is attached to gate valve 106 which has an opening 129 which allows for fluid flow through the valve in an open position as is known in the art.

Inlet fluid pressure is applied to the bottom 114 of fluid chamber 110 via port 116, conduit 118 and inlet port 130. A valve 121 allows for venting of fluid pressure within conduit 118.

Outlet fluid pressure is applied to the top portion 113 of fluid cylinder 110 via port 117, conduits 120, 119 and passageway 123 in top plate 115. A vent valve 126 allows venting and connection to an external pressure source to be used to test or reposition the valve.

In this embodiment, the combined weight of valve stem 112, piston 111, and gate valve 106 is sufficient to maintain the valve in an open position as shown in FIG. 3. However should a rupture occur, the pressure differential across the valve will increase, thus causing piston 111 to move upwardly. This will in turn cause gate valve 106 to move upwardly to a closed position.

The inlet and outlet pressure ports could also be located in the pipeline adjacent to the inlet and outlet of the valve, or further upstream of the inlet and further downstream of the outlet to increase the pressure drop across the control ports.

Grooves or serrations 88 or other types of surface roughness as shown in FIG. 2 in flow path 91 may be machined or otherwise provided to the inside surface of the central valve housings in all the embodiment to increase the pressure drop across the valve. Additionally valves may be provided in control lines 21, 26, 39, 53; and 118, 120. Although the present invention and its advantages have been described in detail, it should be understood that various changes, substitutions and alterations may be made herein without departing from the spirit and scope of the invention as defined by the appended claims.

What is claimed is:

1. An automatic shutoff valve for a pipeline comprising:
a) a housing having an inlet and an outlet;
b) a valve closure element positioned within the housing,
c) a valve stem connected at a first position to the valve closure element and connected at a second portion to a piston located within a fluid chamber;
d) means for communicating an inlet pressure of the valve to a first side of the piston and for communicating an outlet pressure of the valve to a second side of the piston, and
e) means for maintaining the valve closure element in an open position during normal operation of the valve.

2. A valve as claimed in claim 1 wherein the means for maintaining the valve closure element in an open position includes one or more weights connected to the valve stem.

3. A valve as claimed in claim 1 wherein the means for communicating an inlet pressure to a first side of the piston includes a port in the pipeline upstream of the inlet and a conduit extending between the port and the fluid chamber.

4. A valve as claimed in claim 3 wherein the means for communication an outlet pressure to a second side of the piston includes a second port in the pipeline downstream of the outlet and a conduit extending between the second port and the fluid chamber.

5. A valve as claimed in claim 1 wherein the valve closure element is a flapper valve.

6. A valve as claimed in claim 1 wherein the valve closure element is a gate valve.

7. A valve as claimed in claim 1 wherein the housing includes an internal flow path having a roughened portion to increase the pressure drop across the valve.

8. A valve as claimed in claim 1 wherein the means for maintaining the valve closure element in an open position comprises the combined weight of the valve closure element, the valve stem, and the piston.
